(19) United States
(12) Patent Application Publication
(10) Pub. No.: US 2002/0170411 A1
(43) Pub. Date: Nov. 21, 2002

(54) Corrugated percussion instrument necktie

(76) Inventor: Laura Corbin Geisen, North Branch, MN (US)

Correspondence Address: Laura C. Geisen, 9536 380th Street, North Branch, MN, 55056, US

(21) Appl. No.: 09/829,216

(22) Filed: Apr. 9, 2001

(51) Int. Cl. G10D 13/08

(52) U.S. Cl. 84/402

(57) ABSTRACT

An improved percussion instrument having a single piece of rigid material which includes two distinct portions (FIGS. 1, 2, 5 and 6): an upper non-corrugated segment (10), and a lower corrugated segment (12). The material is shaped, sized and worn like a necktie by a downwardly appending hook member (18) attached over the user's collar (FIGS. 1, 2, 5, and 6). Stabilizing tabs (14a and 14b) are inserted underneath the user's collar lapels to stabilize the necktie during its use as a percussion instrument. The user rubs various tools up and down the corrugations (22) to produce percussive sounds.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

This invention relates to the field of musical instruments, more particularly to percussion instruments worn as articles of clothing.

The inspiration for the CORRUGATED PERCUSSION INSTRUMENT NECKTIE was a traditional corrugated metal washboard used for hand washing articles of clothing. The washboard was also used as a percussion instrument by different cultural groups in the United States. For example, the hill people of West Virginia and the Creole people of Louisiana used the metal washboard as a percussion instrument by rubbing spoons or other metal tools up and down the corrugation of the metal to accompany singers or guitar players gathered on front porches for music making. However, one hand was required to hold the washboard upright leaving only one hand to play percussion.

In the mid 1950's a Creole singer and musician named Clifton Chenier popularized a style of music called “la-la music,” later known as zydeco music. Chenier's band featured a percussion instrument that was a metal, wooden-framed washboard hung around the neck of a musician with a string so that the musician could use two hands to play. However, the string was uncomfortable to the user's neck, and provided no mechanism for stabilizing the instrument during use, nor was it desirable as a clothing accessory, in particular a necktie.

Thereafter, Chenier fashioned a mock-up of a variation on the metal washboard with string, and commissioned a metal worker to manufacture a “frottoir.” This instrument resembled a large, corrugated metal bib that was affixed to the musician's chest by two rounded hooks, one at each shoulder, going over the top of the shoulder and onto the shoulder blade, thereby allowing the musician to wear the frottoir and play percussion with two hands. However, the size and dimensions of the frottoir determined its use to be primarily for the purpose of making percussive sound, not for the purpose of accessorizing clothing, as would a necktie.

Several types of supports or harnesses have been proposed for wearing various percussion instruments. For example, U.S. Pat. No. 2,862,412 proposes a bar support in order that a marching band member can play a horizontal xylophone. The bar support allows only one hand free to play, the other being required to hold the base of the bar support.

U.S. Pat. No. 2,140,429 proposes an attachment composed of a belt and shoulder attachments allowing two hands free to play a vertically inclined glockenspiel. U.S. Pat. No. 3,272,056 proposes a mechanism of supporting a xylophone in a horizontal position in front of the user's body. U.S. Pat. No. 1,810,519 proposes a mechanism of supporting a glockenspiel in a horizontal position in front of the user's body. In these cases, the instruments' support is derived from shoulder straps and belts. The belt and shoulder straps, in addition to the size and positioning of the instruments, preclude their use as a clothing accessory.

U.S. Pat. No. Des. 318,754 and U.S. Pat. No. Des. 398,435 and Des. 320,499 and 3,284,807 and 1,347,359 propose neckties whose purpose is for ornamentation as a necktie and do not function as a percussion instrument.

In addition, there are many more musical instruments worn and played in the center of the user's chest or in front of the user's face, including, but not limited to an accordion, harmonica, guitar, drum and even the one-man band. Harmonica examples include U.S. Pat. Nos. 5,619,001 and 5,929,352 and 4,739,686 and 5,608,177 which propose harmonica holders that position a harmonica in front of the user's face by a support going around the neck, and upright braces to hold the harmonica. The disadvantage of these patents is that the user cannot wear their harmonica as a necktie in a social setting. U.S. Pat. No. 5,718,364 proposes a harmonica shoulder holster to carry a plurality of harmonicas. The harmonica shoulder holster, which includes a pants strap, leg strap, shoulder strap and a plurality of pockets, satisfies its objective and purpose of carrying harmonicas, but does not describe a necktie.

The previously cited musical instruments suffer from a number of disadvantages:

(a) The instruments' sizes, shapes and positioning next to the body are too visually cumbersome to consider them as a necktie;

(b) The instruments' sizes, shapes and positioning next to the body are too physically cumbersome to consider them as a necktie;

(c) Their support mechanism or attachment requires the use of one hand;

(d) Their support mechanism or attachment includes an extensive system of belts and harnesses which are visible;

(e) Their support mechanism or attachment is uncomfortable to the user;

(f) Their support mechanism or attachment is unstable to a percussion instrument;

(g) Their purpose is for ornamentation as a necktie only and they do not function as a percussion instrument.

### BRIEF SUMMARY OF THE INVENTION

The CORRUGATED PERCUSSION INSTRUMENT NECKTIE is a percussion instrument of a corrugated rigid material, worn for ornamentation as a necktie. The CORRUGATED PERCUSSION INSTRUMENT NECKTIE is attached at the user's collar by means of a downwardly appending hook member, stabilized by two tabs concealed underneath the user's collar lapels. The raised portions of the corrugation, when rubbed by a variety of tools, including but not limited to thimbles, car keys, and coins, emit a percussive sound.

Accordingly, several objects and advantages of the CORRUGATED PERCUSSION INSTRUMENT NECKTIE are:

(a) to allow the user the ability to wear a CORRUGATED PERCUSSION INSTRUMENT NECKTIE as visually unobtrusive and appealing as a man's necktie;

(b) the size, shape and positioning of the CORRUGATED PERCUSSION INSTRUMENT NECKTIE resemble a man's necktie;

(c) the support mechanism allows two hands free to play the CORRUGATED PERCUSSION INSTRUMENT NECKTIE;

(d) the attachment mechanism and support for the CORRUGATED PERCUSSION INSTRUMENT NECKTIE include a downwardly appending hook member, and a pair of stabilizing tabs worn at the user's collar and hidden from view under the collar lapels;

(e) to allow the user the ability to wear the CORRUGATED PERCUSSION INSTRUMENT NECKTIE by a comfortable and nonrestrictive support mechanism;

(f) to allow the user the ability to play the CORRUGATED PERCUSSION INSTRUMENT NECKTIE stabilized by a pair of stabilizing tabs;

(g) to allow the user the ability to wear an ornamental necktie that also functions as a percussion instrument.

Still further objects and advantages will become apparent from a consideration of the ensuing description and drawings.

### BRIEF DESCRIPTION OF THE SEVERAL VIEWS OF THE DRAWING

The accompanying drawings further describe the invention, wherein:

FIG. 1 is a front elevational view thereof;

FIG. 2 is a rear elevational view thereof;

FIG. 3 is a top plan view thereof;

FIG. 4 is a bottom plan view thereof;

FIG. 5 is a right side elevational view thereof, the left side being a mirror image;

FIG. 6 is an isometric view thereof.

LIST OF REFERENCE NUMERALS IN DRAWINGS

| | | | |
|---|---|---|---|
| 10 | upper non-corrugated | 12 | lower corrugated segment |
| | segment | | |
| 14a | stabilizing tab | 14b | stabilizing tab |
| 16 | lowest tip | 18 | downwardly appending hook |
| | | | member |
| 20 | knot portion | 22 | corrugations |
| 24 | base of downwardly | 26 | intersection of stabilizing tabs |
| | appending hook member | | |

### DETAILED DESCRIPTION OF THE INVENTION

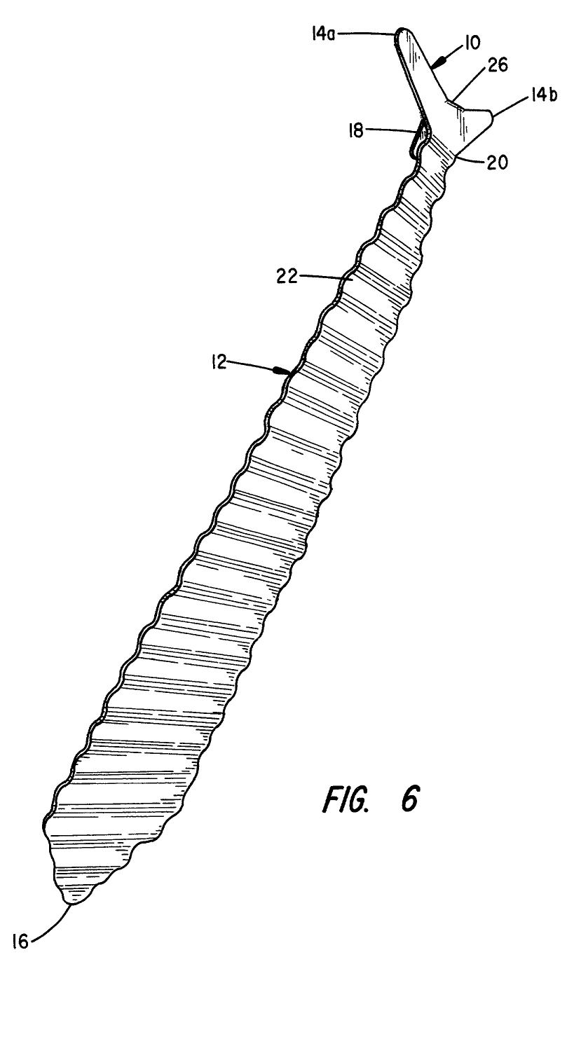

The CORRUGATED PERCUSSION INSTRUMENT NECKTIE includes a single piece of corrugated rigid material shaped and sized like a man's necktie as featured in FIGS. 1, 2, 3, 4, 5 and 6. The most preferred material for the CORRUGATED PERCUSSION INSTRUMENT NECKTIE is brushed stainless steel, the most preferred thickness being 24 gauge. The single piece of corrugated rigid material includes two distinct portions: an upper non-corrugated segment 10, and a lower corrugated segment 12, which includes a plurality of corrugations 22, meeting at a knot portion 20 of the invention, the knot portion 20 being the narrowest point of the body of the CORRUGATED PERCUSSION INSTRUMENT NECKTIE (FIGS. 1, 2, 6).

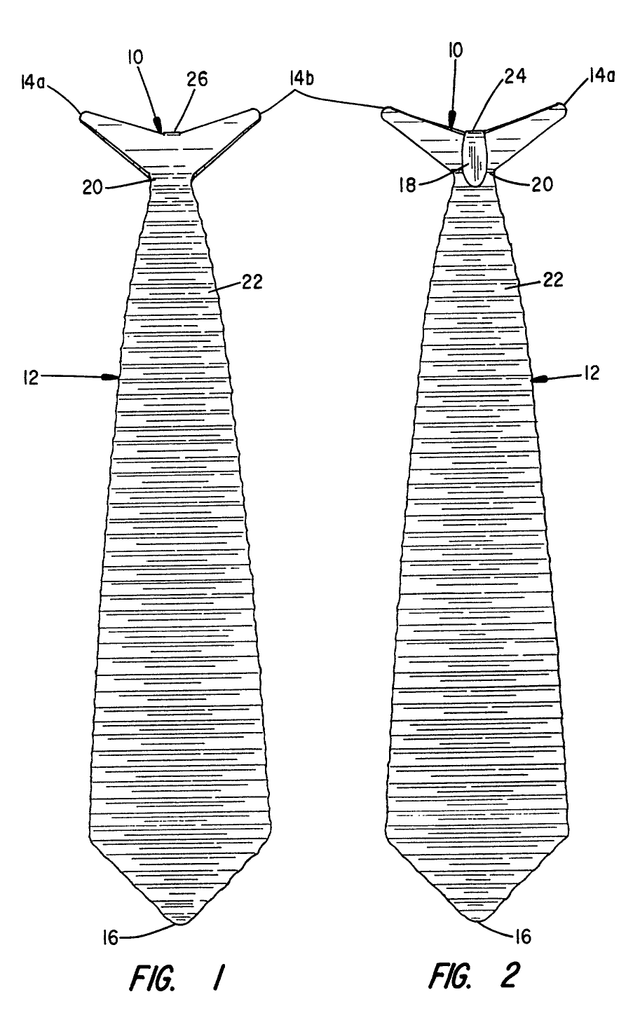

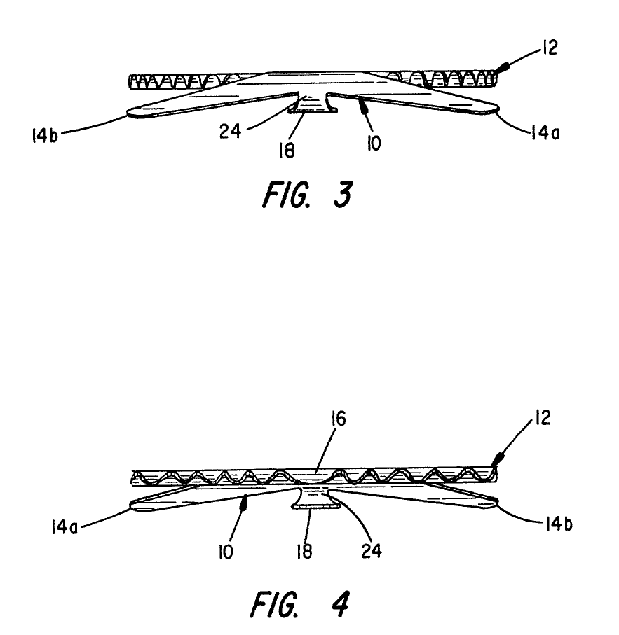

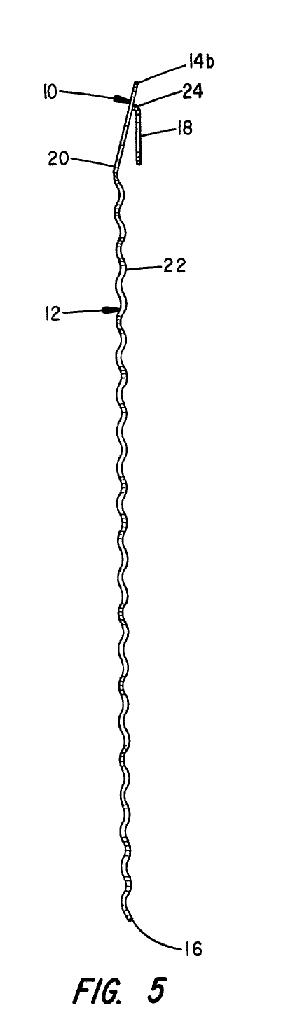

The non-corrugated top portion 10 of the CORRUGATED PERCUSSION INSTRUMENT NECKTIE includes two elements (FIGS. 1 and 2): a pair of stabilizing tabs 14a and 14b, and a downwardly appending hook member 18. The stabilizing tabs 14a and 14b flare out in a wide “V” formation, the preferred measurement of an intersection of stabilizing tabs 26 ranging between 140 and 145 degrees, to allow for the fit of the user's neck. The non-corrugated top portion 10 is angled (FIG. 5) away from the plane of the lower corrugated segment 12, at the preferred measurement of 15 degrees in order to provide operable communication with the user's collarbones (FIGS. 3 and 4). The stabilizing tabs 14a and 14b are to be worn under the user's collar lapels in order to stabilize the CORRUGATED PERCUSSION INSTRUMENT NECKTIE, as well as create the illusion of the stabilizing tabs 14a and 14b encircling the neck of the wearer.

The downwardly appending hook member 18 extends from a base of downwardly appending hook member 24 (FIGS. 2 and 5) located at the intersection of stabilizing tabs 26 (FIG. 1). The downwardly appending hook member 18 descends downward and functions as a hook to hang the CORRUGATED PERCUSSION INSTRUMENT NECKTIE from the collar or neckline of the user (FIGS. 2 and 5). Extending from the non-corrugated upper portion 10 of the invention to a lowest tip 16, are parallel, horizontal corrugations 22 of the rigid material perpendicular to the length of the lower corrugated segment 12. The preferred dimensions of the corrugations 22 being 0.6 inches between the corrugations 12, and 0.15 inches in height from peak to trough.

The manner of using the CORRUGATED PERCUSSION INSTRUMENT NECKTIE is similar to that of wearing a clip on necktie. It begins with the user hanging the CORRUGATED PERCUSSION INSTRUMENT NECKTIE by means of the downwardly appending hook member 18 over her/his buttoned collar or neckline. The user's shirt lapels, if there are any, are positioned over the stabilizing tabs 14a and 14b, so as to conceal the stabilizing tabs 14a and 14b. The stabilizing tabs 14a and 14b provide operable communication with the user's collar bones, due to their manufactured angle, thus providing stabilization during use.

Lastly, the user rubs the corrugations 22 of the lower corrugated segment 12 with tools, such as, but not limited to, metal thimbles, car keys or coins, using one or two hands to produce percussive sounds. The user may rub the corrugations 22 of the lower corrugated segment 12 from the knot portion 20 to the lowest tip 16 in any combination of upward and/or downward strokes with her/his choice of tools.

The manufacturing of the CORRUGATED PERCUSSION INSTRUMENT NECKTIE in the most preferred material, 24 gauge brushed stainless steel, is begun by using a standard sheet metal industry laser or stamping press to cut the steel according to a template of a flattened CORRUGATED PERCUSSION INSTRUMENT NECKTIE. It is preferable to orient the brushing lines vertically.

A sanding device, such as a drum sander, is used to smooth the rough edges, or burrs, left by the laser cutting machine or stamping press. The flat and sanded piece of metal is passed into a pair of interlocking metal gears, beginning at the lowest tip 16 and continuing up until the interlocking gears reach the knot portion 20 of the CORRUGATED PERCUSSION INSTRUMENT NECKTIE. Then the metal is reversed through the interlocking gears, until the metal comes completely out of the interlocking gears, now in its corrugated condition. In addition, the interlocking gears cause the non-corrugated top portion 10 to become angled at the preferred measurement of 15 degrees during the last revolution of the interlocking gears.

To finish, the downwardly appending hook member 18, located at the intersection of stabilizing tabs 26, is manually folded over at the base of downwardly appending hook member 24, flush with the intersection of stabilizing wings 26, such that the base of downwardly appending hook member 24 is not visible in the front view (FIG. 1), and such that a shirt collar has room to fit under the downwardly appending hook member 18 (FIG. 5).

### Additional Embodiments

Preferred materials for the CORRUGATED PERCUSSION INSTRUMENT NECKTIE include, but are not limited to, metal, fiberglass, and plastic. The rigid material may measure at or less than the thickness of 22 gauge. Other embodiments include, but are not limited to, coated, plated or otherwise decorated metal, fiberglass, and plastic. In addition to the downwardly appending hook member 18 secured to the user's collar or neckline, other securing mechanisms may be used, such as but not limited to, a cord, strap or support around the user's neck upon which the downwardly appending hook member 18 is secured, or to which the stabilizing tabs are secured.

The stabilizing tabs 14a and 14b which flare out in a wide “V” formation, may be measured at an angle between 135 to 150 degrees at the intersection of stabilizing tabs 26, to allow for the fit of the user's neck. The non-corrugated top portion 10 may be angled (FIG. 5) away from the plane of the lower corrugated segment 12, between 10 to 20 degrees.

It is to be understood, however, that even though numerous characteristic and advantages of the present invention have been set forth in the foregoing description, together with details of the structure and function of the invention, the disclosure is illustrative only, and changes may be made in detail, especially in matters of shape, size and material within the principles of the invention to the full extent indicated by the broad general meaning of the terms in which the appended claims are expressed.

I claim:

1. A percussion instrument that attaches to the collar of the user's shirt, whereby the user may wear said percussion instrument as a necktie while playing it as a percussion instrument.

2. The percussion instrument of claim 1 wherein said percussion instrument is comprised of a piece of rigid material having a sufficient size and shape to represent a necktie.

3. The percussion instrument of claim 2 wherein said percussion instrument is made of brushed stainless steel.

4. The percussion instrument of claim 3 wherein said percussion instrument is comprised of an upper non-corrugated segment and a lower corrugated segment.

5. The percussion instrument of claim 4 wherein said lower corrugated segment is comprised of a plurality of corrugations, wherein said corrugations are perpendicular to the length of said percussion instrument.

6. The percussion instrument of claim 5 wherein said corrugations are greater than 0.1 inches in height from peak to trough, and greater than 0.3 inches in distance between said corrugations.

7. The percussion instrument of claim 4 wherein said upper non-corrugated segment is angled away from the plane of said percussion instrument at an angle greater than 10 degrees.

8. The percussion instrument of claim 1 wherein a means for attaching said percussion instrument is a downwardly appending hook member.

9. The percussion instrument of claim 1 wherein a means for stabilizing is a pair of stabilizing tabs.

10. The percussion instrument of claim 9 wherein said stabilizing tabs form an angle arranged to provide a measurement between 140 to 145 degrees at the user's neck.

11. A necktie wherein the user can play said necktie as a percussion instrument.

12. The necktie of claim 11 wherein said necktie is comprised of a piece of rigid material having a sufficient size and shape to represent a necktie.

13. The necktie of claim 12 wherein said necktie is made of brushed stainless steel.

14. The necktie of claim 13 wherein said necktie is comprised of an upper non-corrugated segment and a lower corrugated segment.

15. The necktie of claim 14 wherein said upper non-corrugated segment is angled away from the plane of said necktie at an angle greater than 10 degrees.

16. The necktie of claim 14 wherein said lower corrugated segment is comprised of a plurality of corrugations, wherein said corrugations are perpendicular to the length of said necktie.

17. The necktie of claim 16 wherein said corrugations are greater than 0.1 inches in height from peak to trough, and greater than 0.3 inches in distance between said corrugations.

18. The necktie of claim 11 wherein a means for attaching said necktie is a downwardly appending hook member.

19. The necktie of claim 11 wherein a means for stabilizing is a pair of stabilizing tabs.

20. The necktie of claim 19 wherein said stabilizing tabs form an angle arranged to provide a measurement between 140 to 145 degrees at the user's neck.

21. A method of attaching a musical instrument to the user's collar.

22. The method of claim 21 wherein said method is comprised of:
a) a pair of stabilizing tabs,
b) a downwardly appending hook member.

23. The method of claim 22 wherein said stabilizing tabs form an angle arranged to provide a measurement between 140 to 145 degrees at the user's neck.

24. The method of claim 23 wherein said downwardly appending hook member is located at the intersection of said stabilizing hooks.

25. The method of claim 24 wherein said downwardly appending hook member descends downward and functions as a hook to hang said musical instrument.
